(19) United States
(12) Patent Application Publication
(10) Pub. No.: US 2010/0155063 A1
(43) Pub. Date: Jun. 24, 2010

(54) Particle Drilling System Having Equivalent Circulating Density

(75) Inventors: Gordon A. Tibbitts, Murray, UT (US); Greg Galloway, Conroe, TX (US); Adriane Vuyk, JR., Houston, TX (US); Jim Terry, Houston, TX (US)

Correspondence Address: ARNOLD & KNOBLOCH, L.L.P., 4900 Woodway Dr., Suite 900, HOUSTON, TX, 77056, US

(73) Assignee: PDTI Holdings, LLC, Houston, TX (US)

(21) Appl. No.: 12/641,720

(22) Filed: Dec. 18, 2009

Related U.S. Application Data
(60) Provisional application No. 61/140,474, filed on Dec. 23, 2008.

(51) Int. Cl. E21B 43/16; C09K 8/02

(52) U.S. Cl. 166/275; 175/65

(57) ABSTRACT

An injection system and method is described. In several exemplary embodiments, the injection system and method may be a part of, and/or used with, a system and method for excavating a subterranean formation. The system and method include a low density material injection to lower the circulating fluid equivalent circulating density.

### RELATED APPLICATIONS

This application claims priority to and the benefit of application Ser. No. 61/140,474, filed on Dec. 23, 2008.

### BACKGROUND OF THE INVENTION

### 1. Field of the Invention

The present disclosure relates to the field of oil and gas exploration and production. More specifically, the present disclosure concerns a system and method for subterranean excavation for adjusting circulating fluid density when excavating with particles and/or impactors.

2. Description of Related Art

Boreholes for producing hydrocarbons within a subterranean formation are generally formed by a drilling system employing a rotating bit on the lower end of a drill string. The drill string is suspended from a derrick which includes a stationary crown block assembly connected to a traveling block via a steel cable that allows movement between the two blocks. The drill string can be rotated by a top drive or Kelly above the borehole entrance. Drilling fluid is typically pumped through the drill string that then exits the drill bit and travels back to the surface in the annulus between the drill string and wellbore inner circumference. The drilling fluid maintains downhole pressure in the wellbore to prevent hydrocarbons from migrating out of the formation cools and lubricates the bit and drill string, cleans the bit and bottom hole, and lifts the cuttings from the borehole. The drilling bits are usually one of a roller cone bit or a fixed drag bit.

Impactors have recently been developed for use in subterranean excavations. In FIG. 1 a schematic example of an impactor excavating system 10 is shown in a partial sectional view. Drilling fluid is provided by a fluid supply 12, a fluid supply line 14 connected to the fluid supply 12 conveys the drilling fluid to a pump 15 where the fluid is pressurized to provide a pressurized drilling circulating fluid. An impactor injection 16 introduces impactors into the fluid supply line 14; inside the fluid supply line 14, the impactors and circulation fluid mix to form a slurry 19. The slurry 19 flows in the fluid supply line 14 to a drilling rig 18 where it is directed to a drill string 20. A bit 22 on the lower end of the drill string 20 is used to form a borehole 24 through a formation 26. The slurry 19 with impactors 17 is discharged through nozzles 23 on the bit 22 and directed to the formation 26. The impactors 17 strike the formation with sufficient kinetic energy to fracture and structurally alter the subterranean formation 26. Fragments are separated from the formation 26 by the impactor 17 collisions. Material is also broken from the formation 26 by rotating the drill bit 22, under an axial load, against the borehole 24 bottom. The separated and removed formation mixes with the slurry 19 after it exits the nozzles 23; the slurry 19 and formation fragments flow up the borehole 20 in an annulus 28 formed between the drill string 24 and the borehole 20. Examples of impactor excavation systems are described in Ser. No. 10/897,196, filed Jul. 22, 2004 and Curlett et al., U.S. Pat. No. 6,386,300; both of which are assigned to the assignee of the present application and both of which are incorporated by reference herein in their entireties.

Adding the dense impactors 17 increases the circulating fluid's equivalent circulation density (ECD). In some instances the impactors' 17 density sufficiently exceeds the circulation fluid density to form a slurry 19 that creates an overbalance in the borehole 24. If the overbalance surpasses the formation 26 pore pressure, the slurry 19 (circulating fluid and impactors 17) can migrate into the formation 26. This is undesirable for many reasons, including damaging a potential hydrocarbon production zone and losing circulation fluid and impactors 17 into the formation 26.

### BRIEF SUMMARY OF THE INVENTION

Disclosed herein is an example of excavating a borehole with an excavating system that employs circulation flow having an impactor laden slurry. A material may be added to the circulation flow that has a density less than at least the impactors in the circulation flow to define a low density material. The material addition can be added to lower the equivalent circulating density in the circulation flow so that pressure in the wellbore is less than formation pore pressure adjacent the wellbore. The equivalent circulating density, and/or the pressure in the wellbore can be adjusted to a pre-determined value by addition of the low density material. If necessary, the equivalent circulating density and/or wellbore pressure, can be increased above the pre-determined value.

### BRIEF DESCRIPTION OF THE DRAWINGS

FIG. 1 is a schematic view of a prior art excavation system.

FIG. 2 is a side sectional view of an excavation system that includes a lower density material injection.

FIG. 3 depicts slurry mixed with a lower density material exiting a drill bit.

FIGS. 4A-4C portray an example of a hollow gas filled low density particle, before, during, and after formation impact.

FIG. 5 is a flowchart depicting an example of a method disclosed herein.

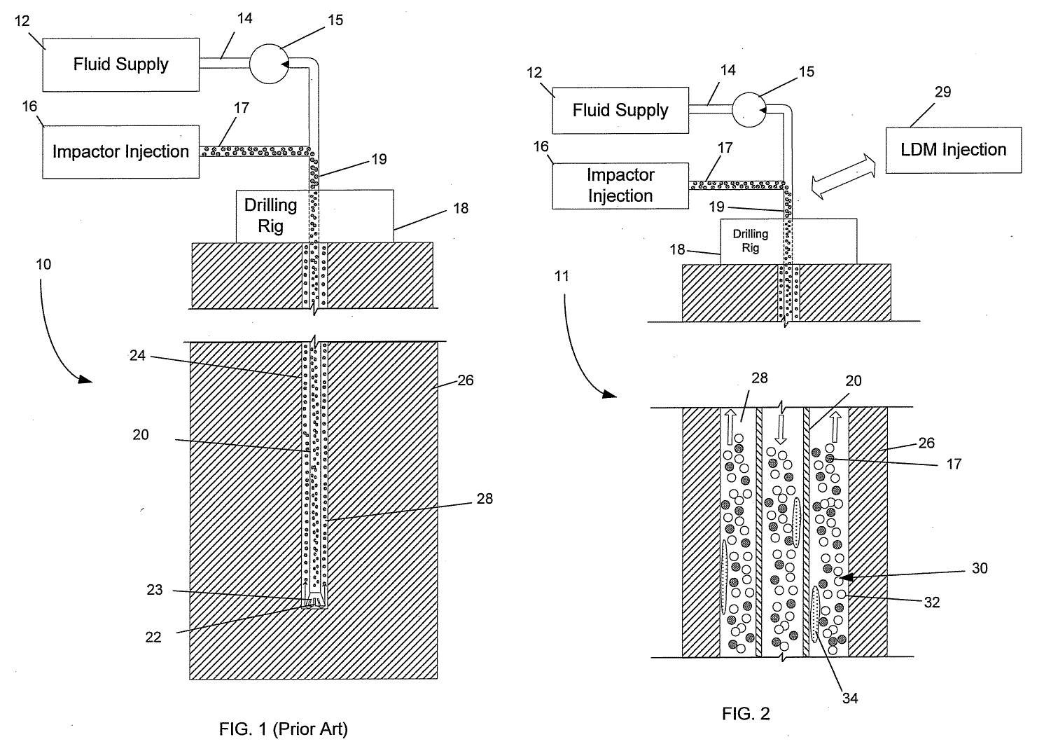

### DETAILED DESCRIPTION OF THE ILLUSTRATIVE EMBODIMENTS

In the drawings and description that follows, like parts are marked throughout the specification and drawings with the same reference numerals, respectively. The drawings are not necessarily to scale. Certain features of the disclosure may be shown exaggerated in scale or in somewhat schematic form and some details of conventional elements may not be shown in the interest of clarity and conciseness. The present disclosure is susceptible to embodiments of different forms. Specific embodiments are described in detail and are shown in the drawings, with the understanding that the present disclosure is to be considered an exemplification of the principles of the disclosure, and is not intended to limit the disclosure to that illustrated and described herein. It is to be fully recognized that the different teachings of the embodiments discussed below may be employed separately or in any suitable combination to produce desired results. The various characteristics mentioned above, as well as other features and characteristics described in more detail below, will be readily apparent to those skilled in the art upon reading the following detailed description of the embodiments, and by referring to the accompanying drawings.

To prevent borehole 20 wall degradation from a high density circulating slurry, it is beneficial to reduce the ECD; which can thereby prevent fluid losses into the formation 26. In one example of use, the circulating fluid density is reduced so that the pressure in the borehole 20 is less than the pore pressure in the formation 26. Alternatively, in situations where formation 26 pore pressure changes with depth, the ECD is adjusted based on the pore pressure of the formation 26 that is adjacent the borehole 20.

In one embodiment, the fluid or slurry 19 density is changed by adding a material having a different density. In an example, a material having a density (specific gravity) lower than the impactor 17 density is added to the fluid. Optionally, the lower density material can be added to the slurry 19. Factors affecting the amount of added material are, the added material density, the impactor density, the fluid density, and desired ECD. However, it is well within the capabilities of those skilled in the art to determine the amount of added material as well as a desired ECD.

FIG. 2 illustrates in a side sectional view, an embodiment of a particle impactor excavating system 11 that includes a low density material (LDM) injection 29. The LD injection 29 supplies low density material for addition to the flow within the borehole 24. In one example, the LDM density is less than at least the impactor 17 density. The LDM injection 29 can connect to the fluid supply 12, the fluid line 14, or the impactor injection 16. The LDM injection 29 to the fluid line 14 can be upstream or downstream of the pump 15, upstream or downstream of the intersection with the impactor injection 16, and/or upstream, within, or after the drilling rig 18. Additionally, the LDM injection 29 can be at multiple locations. In one example of use, adding the LDM to the borehole 24 replaces impactors 17. The replacement can be a volumetric flow rate replacement, so that substituting impactors 17 with the lower density LDM reduces circulating flow density in the borehole 24. In one example the weight percent of replaced impactors 17 is by about 10% of the impactors 17 in the circulating flow.

In the borehole 24, an example is illustrated of a mixture 30 of impactor 17 laden slurry 19 combined with a lower density material. Examples of a LDM illustrated in FIG. 2 are low density elements 32 and amorphous substances 34. The low density elements 32 can be hollow fluid filled bodies, the bodies can comprise metallic, polymeric, oligomeric, as well as ceramic substances. The fluid in the bodies can be liquid or a gas. The metallic substances include elastic materials such as alloys of iron, copper, nickel, cobalt, and the like. The polymeric and oligomeric substances include rubber, urethane, polyurethane, polypropylene, and the like. Amorphous substances can be fluids that when added can be liquid or vapor, and including liquids that change phase into a vapor under certain environmental downhole conditions. The LDM can also be a frangible material, a foam, materials that coalesce with the circulation fluid, materials that decay during circulation, and combinations thereof, to name a few.

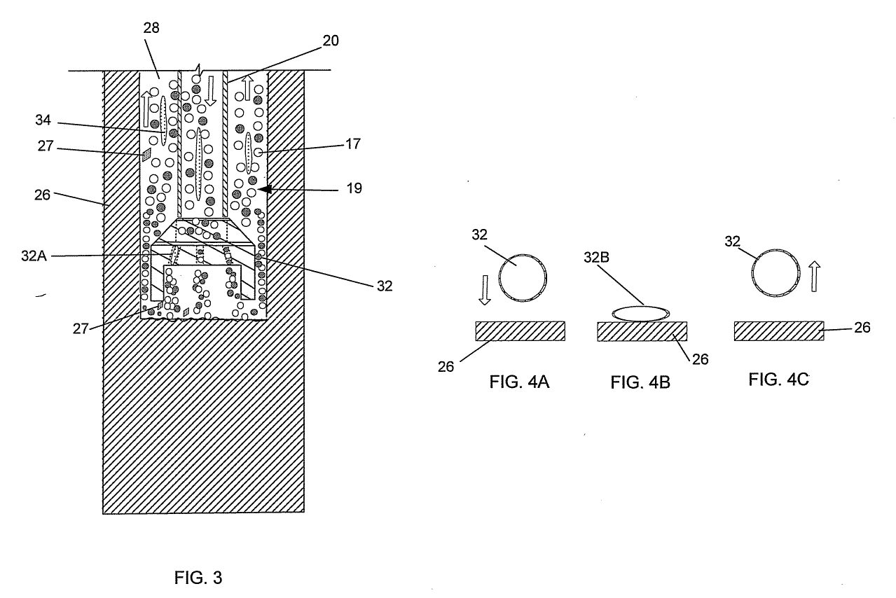

FIG. 3 provides a side partial sectional view of an example of a bit 22 of an impactor excavating system 10 at borehole 20 bottom. As shown, the system 10 is forming the borehole 24 using a mixture 30 of low density elements 32 and impactor 17 laden slurry 19. The mixture 30 flows downward within the drill string 20, to nozzles 23 in the drill bit 22, then exits the nozzles 23 where it is directed at the formation 26 in the borehole 24 bottom. An example of an elastomeric low density element 32A is depicted, wherein the element 32A diameter is greater than the nozzle 23 diameter. The supple nature of the element 32A combined with the high pressure differential across the nozzles 23, deforms the element 32A as it forces it through the nozzle 23. As noted above, the impactors 17 and drill bit 22, fracture and/or break the formation to produce formation fragments 27. After exiting the drill big 22, the mixture 30, along with the formation particles 27, flows up the annulus 28.

FIGS. 4A-4C respectively illustrate an example of an elastic low density element 32 prior to, during, and after it strikes the formation 26. In FIG. 4A, the low density element 32 is substantially spherical. As shown in FIG. 4B, in response to striking the formation 26, the element 32B temporarily deforms into an elliptically shape. FIG. 4C depicts an elastic low density element 32 shown returning to its original shape of FIG. 4A after rebounding from the formation 26. Depending on the respective properties of the rock in the formation 26 and materials forming the low density element 32; formation fragments 27 mayor may not be formed when the low density element 32 strikes the borehole 24 bottom. Optionally, the low density element 32 can be formed from a frangible substance that fractures on impacting the formation 26 and releases a fluid inside of the element 32.

Each of the individual impactors 17 is structurally independent from the other impactors. For brevity, the plurality of solid material impactors 17 may be interchangeably referred to as simply the impactors 17. The plurality of solid material impactors 17 may be substantially rounded and have either a substantially non-uniform outer diameter or a substantially uniform outer diameter. The solid material impactors 17 may be substantially spherically shaped, non-hollow, formed of rigid metallic material, and having high compressive strength and crush resistance, such as steel shot, ceramics, depleted uranium, and multiple component materials. Although the solid material impactors 17 may be substantially a non-hollow sphere, alternative embodiments may provide for other types of solid material impactors, which may include impactors 17 with a hollow interior. The impactors may be magnetic or nonmagnetic. The impactors may be substantially rigid and may possess relatively high compressive strength and resistance to crushing or deformation as compared to physical properties or rock properties of a particular formation or group of formations being penetrated by the borehole 24.

The impactors may be of a substantially uniform mass, grading, or size. The solid material impactors 17 may have any suitable density for use in the excavation system 10. For example, the solid material impactors 17 may have an average density of at least 470 pounds per cubic foot. Alternatively, the solid material impactors 17 may include other metallic materials, including tungsten carbide, copper, iron, or various combinations or alloys of these and other metallic compounds. The impactors 17 may also be composed of non-metallic materials, such as ceramics, or other man-made or substantially naturally occurring non-metallic materials. Also, the impactors 17 may be crystalline shaped, angular shaped, sub-angular shaped, selectively shaped, such as like a torpedo, dart, rectangular, or otherwise generally non-spherically shaped.

The circulation fluid may be substantially continuously circulated during excavation operations to circulate at least some of the plurality of solid material impactors 17 and the formation fragments 17 away from the nozzle 23. The impactor 17 laden slurry 19 and the low density material circulated away from the nozzle 23 may be circulated substantially back to the drilling rig 18, or circulated to a substantially intermediate position between the rig 18 and the nozzle 23.

A substantial portion by weight of the solid material impactors 17 may apply at least 5000 pounds per square inch of unit stress to a formation 26 to create a structurally altered zone in the formation. The structurally altered zone is not limited to any specific shape or size, including depth or width. Further, a substantial portion by weight of the impactors 17 may apply in excess of 20,000 pounds per square inch of unit stress to the formation 26 to create the structurally altered zone in the formation 26. The mass-velocity relationship of a substantial portion by weight of the plurality of solid material impactors 17 may also provide at least 30,000 pounds per square inch of unit stress.

A substantial portion by weight of the solid material impactors 17 may have any appropriate velocity to satisfy the mass-velocity relationship. For example, a substantial portion by weight of the solid material impactors may have a velocity of at least 100 feet per second when exiting the nozzle 23. A substantial portion by weight of the solid material impactors 100 may also have a velocity of at least 100 feet per second and as great as 1200 feet per second when exiting the nozzle 23. A substantial portion by weight of the solid material impactors 17 may also have a velocity of at least 100 feet per second and as great as 750 feet per second when exiting the nozzle 23. A substantial portion by weight of the solid material impactors 17 may also have a velocity of at least 350 feet per second and as great as 500 feet per second when exiting the nozzle 23.

A substantial portion by weight of the impactors 17 may engage the formation 26 with sufficient energy to enhance creation of a borehole 24 through the formation 26 by any or a combination of different impact mechanisms. First, an impactor 17 may directly remove a larger portion of the formation 26 than may be removed by abrasive-type particles. In another mechanism, an impactor 17 may penetrate into the formation 26 without removing formation material from the formation 26. A plurality of such formation penetrations, such as near and along an outer perimeter of the borehole 20 may relieve a portion of the stresses on a portion of formation 26 being excavated, which may thereby enhance the excavation action of other impactors 17 or the drill bit 22. Third, an impactor 17 may alter one or more physical properties of the formation 26. Such physical alterations may include creation of micro-fractures and increased brittleness in a portion of the formation 26, which may thereby enhance effectiveness the impactors 17 in excavating the formation 26. The constant scouring of the bottom of the borehole also prevents the build up of dynamic filtercake, which can significantly increase the apparent toughness of the formation 26.

In one example of use, fluid circulating pump discharge pressure may range from about 1500 pounds per square inch and in excess of about 6000 pounds per square inch, from about 1500 pounds per square inch to about 2500 pounds per square inch, from about 2500 pounds per square inch to about 6000 pounds per square inch, and all values between about 1500 pounds per square inch and about 6000 pounds per square inch. Higher pressures likely lead to increased drilling capabilities and greater penetration of impactors. Accordingly, in an optional embodiment, pump discharge pressures may range from about 1000 pounds per square inch to about 10,000 pounds per square inch.

It is understood that variations may be made in the foregoing without departing from the scope of the disclosure. Any spatial references such as, for example, “upper,” “lower,” “above,” “below,” “radial,”” axial,” “between,” “vertical,” “horizontal,” “angular,” “upward,” “downward,” “side-to-side,” “left-to-right,” “right-to-left,” “top-to-bottom,” “bottom-to-top,” etc., are for the purpose of illustration only and do not limit the specific orientation or location of the structure described above. As used herein, the terms “about” and “approximately” are understood to refer to values which are within a reasonable range of uncertainty of the number being modified by the terms. In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with anyone or more of the other above-described embodiments and/or variations.

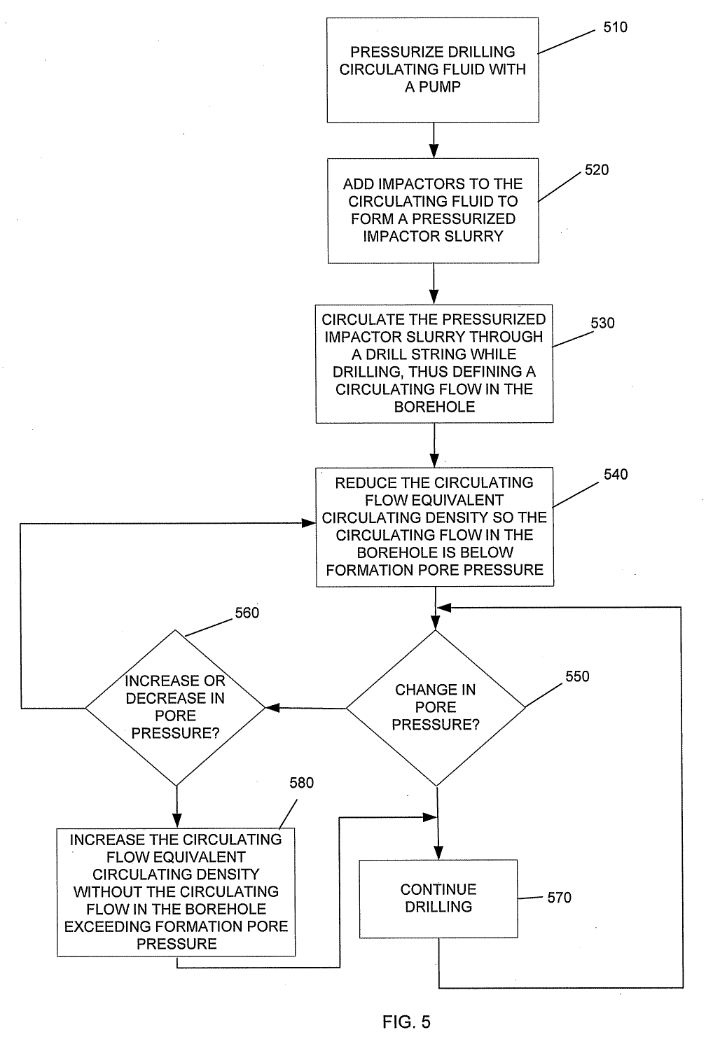

An example of a method of lowering circulating fluid ECD is illustrated in the flowchart of FIG. 5. In step 510, a fluid used in excavating or drilling with an impactor excavation system is pressurized with a pump or pumps. The pumped or pressurized fluid, which is used for circulating within a borehole during a drilling operation, is defined as a pressurized drilling circulating fluid. Impactors, as described above, are added to the pressurized drilling circulating fluid in step 520 to form a pressurized impactor slurry. In step 530 the pressurized impactor slurry is directed to a drill string that is disposed in a wellbore. The drill string includes a drill bit on its lower end having at least one nozzle. As described above and shown in step 530, the pressurized impactor slurry circulates as a circulating flow through the drill string and wellbore annulus. In step 540 the equivalent circulating density of the circulating flow is reduced to a pre-determined threshold value so that fluid static head in the wellbore is less than the pore pressure adjacent the borehole. As the borehole is deepened, the pore pressure can change; this can be monitored (step 550). If the pore pressure remains relatively constant, drilling/excavating can continue (step 570). Optionally, it can be determined in step 560 if the change is an increase or decrease in pore pressure. If there is an increase in pore pressure, the circulating flow equivalent circulating density can be increased, as shown in step 580. The increase in equivalent circulating density can be up to the pre-determined threshold value. After increasing the equivalent circulating density, the method can return to step 570 to continue drilling. If in step 560 the pore pressure decreases, the method can return to step 540 to correspondingly reduce the equivalent circulating density so that column pressure does not exceed pore pressure.

Although several exemplary embodiments have been described in detail above, the embodiments described are exemplary only and are not limiting, and those skilled in the art will readily appreciate that many other modifications, changes and/or substitutions are possible in the exemplary embodiments without materially departing from the novel teachings and advantages of the present disclosure. Accordingly, all such modifications, changes and/or substitutions are intended to be included within the scope of this disclosure as defined in the following claims. In the claims, means-plus-function clauses are intended to cover the structures described herein as performing the recited function and not only structural equivalents, but also equivalent structures.

What is claimed is:

1. A method of excavating a borehole through a subterranean formation comprising:
(a) pumping a supply of drilling fluid with a pump to supply a pressurized drilling circulating fluid to a drill string;
(b) adding impactors to the pressurized circulating fluid downstream of the pump to form a pressurized impactor slurry;
(c) providing a circulating flow for excavating the borehole by directing the pressurized impactor slurry to the drill string in the borehole that has on its lower end a drill bit with one or more nozzles;
(d) reducing equivalent circulating density (ECD) of the circulating flow of the pressurized impactor slurry; and
(e) orienting the drill bit in the borehole, so that the reduced ECD impactor slurry exits the drill bit nozzles and contacts the formation.

2. The method of claim 1, wherein the step of reducing the ECD comprises providing a material having a density lower than at least the impactor within the pressurized impactor slurry, to thereby define a low density material (LDM), and adding the LDM to one of the circulating fluid, the impactors, the slurry, or combinations thereof.

3. The method of claim 2, wherein the LDM is selected from the list consisting of a fluid, a solid, a hollow object, a hollow fluid filled object, phase changing materials, a property changing material, frangible materials, decaying materials, permeable materials, and combinations thereof.

4. The method of claim 3, wherein the hollow fluid filled object comprises an outer shell formed from a material selected from the list consisting of a metallic substance, an elastomeric substance, a frangible substance, and combinations thereof.

5. The method of claim 2, wherein the added LDM replaces impactors in the pressurized impactor slurry.

6. The method of claim 5, wherein the added LDM reduces the weight percentage of impactors in the pressurized impactor slurry by about 10%.

7. The method of claim 1, further comprising reducing the circulating flow ECD below a pre-selected threshold value so that the pressure in the borehole is less than the formation pore pressure.

8. The method of claim 7, further comprising increasing the ECD above the preselected threshold value.

9. A system for excavating a borehole through a subterranean formation comprising:
a supply of pressurized impactor laden slurry;
a drill string in a borehole in communication with the pressurized impactor laden slurry;
a drill bit on the drill string lower end having nozzles communicating the slurry from the drill string to within the borehole; and
a supply of material having a density less than the impactor density, so that when provided to the pressurized impactor laden slurry in the borehole, the pressure in the borehole is less than the formation pore pressure.

10. The fluid system of claim 9, wherein the material having a density less than the impactor density is selected from the list consisting of a fluid, a solid, a hollow object, a hollow fluid filled object, phase changing materials, a property changing material, frangible materials, decaying materials, permeable materials, and combinations thereof.

11. The fluid system of claim 10, wherein the hollow fluid filled object comprises an outer shell formed from a material selected from the list consisting of a metallic substance, an elastomeric substance, a frangible substance, and combinations thereof.
